(19) United States
(12) Patent Application Publication
(10) Pub. No.: US 2010/0257468 A1
(43) Pub. Date: Oct. 7, 2010

(54) METHOD AND SYSTEM FOR AN ENHANCED INTERACTIVE VISUALIZATION ENVIRONMENT

(76) Inventors: Francisco Javier Gonzalez Bernardo, San Francisco, CA (US); James Keravala, San Francisco, CA (US); Wes Thierry, San Fraccisco, CA (US); Garry Mckinsey, JR., Redwood City, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/755,309

(22) Filed: Apr. 6, 2010

Related U.S. Application Data
(60) Provisional application No. 61/167,052, filed on Apr. 6, 2009.

(51) Int. Cl. G06F 17/00; G06F 3/048

(52) U.S. Cl. 715/760; 715/848; 715/851

(57) ABSTRACT

The present system and method provides an enhanced computing environment for visualizing, managing, organizing, and interacting with digital content in an integrated and user-friendly manner. According to one embodiment, an enhanced computing environment includes a three-dimensional virtual space whose dimensions appear to a user to be greater than the physical dimensions of the computer display. Unconfined by the physical dimensions of the computer display, more digital content elements may be integrated into the enhanced computing environment without obstructing the user's view of other digital content elements.

The present application claims the benefit of and priority to U.S. Provisional Patent Application No. 61/167,052 filed on Apr. 6, 2009, entitled “Method and System for An Enhanced Visualization Environment,” which is herein incorporated by reference.

### FIELD

The field of disclosure relates to an information integration environment, and particularly, a computing environment that enables visualizing, managing, organizing, and interacting with digital content on a 2D-3D platform.

### BACKGROUND

Today, the standard computing environment organizes information two-dimensionally on a computer display as elements. These elements may include Internet browsers, media players, instant messaging windows, or picture slideshows. A user may multitask by generating multiple elements and toggling interactions between the multiple elements. For instance, a user may open up several Internet browser windows at a time and switch between them to perform Internet searches, to send an email, or to watch a streaming movie clip. The user may also rearrange, resize, or interact with elements in the two-dimensional computing environment. However, because the computing environment for displaying the elements is generally limited to the physical dimensions of the computer display, its design inherently faces a number of inefficiencies that limit the user's ability to multitask and manage multiple elements.

As more elements are generated in the standard computing environment, the space for displaying the elements becomes crowded. The elements are generally ‘stacked’ on top of each other such that newly generated elements obstruct the user's view of the existing elements, either partially or entirely. As a way to help the user navigate overlapping elements or elements hidden from the user's view, some prior art computing environments incorporate a taskbar that contains a link to each of the elements existing in the environment. The taskbar typically resides close to an edge of the display such that elements are not permitted to block its view. The user can select each element by activating the corresponding link on the taskbar, such as by ‘clicking’ (depressing a mouse button) on it with the mouse cursor. A selected element is brought to the ‘top’ such that the user has a full view of it and can interact with it.

Although obstructed elements may still be processing in the background, obstructing the view of some elements may be undesirable to the user but nonetheless unavoidable, due to insufficient display space. An example is when the user wants to monitor the activities of several application windows in parallel, perhaps a window for real-time stock quotes, a number of chat windows, and a streaming movie player. Because the user generally has to click through the taskbar to select which elements to view at a given time, navigation can seem cumbersome, making all the informational elements seem isolated to the user. Moreover, the user may encounter information overload when a great number of existing elements are completely hidden from the user's view and there are numerous links on the task bar.

In view of the foregoing, there exists a need for a method and system for an enhanced computing environment for visualizing, managing, organizing, and interacting with digital content in an integrated and user-friendly manner.

### SUMMARY

According to one embodiment, a system for integrating and displaying digital content comprises a desktop client that generates a three-dimensional computing environment; and a computer display that displays the three-dimensional computing environment, wherein the three-dimensional computing environment comprises a three-dimensional virtual space whose dimensions appear to a user to be greater than the physical dimensions of the computer display, and a plurality of elements containing imported digital content.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles described herein.

FIG. 1 illustrates a prior art computing environment;

FIG. 2 illustrates an enhanced computing environment with respect to the user's perspective, according to one embodiment;

FIGS. 3a-3b illustrate two-dimensional navigation in an enhanced computing environment, according to one embodiment;

FIG. 4 illustrates a flow-chart of exemplary operations of the timed stacking module, according to one embodiment;

FIG. 5a-5b illustrate two-dimensional navigation in an enhanced computing environment, according to one embodiment;

FIGS. 6a-6b illustrate two-dimensional navigation in an enhanced computing environment, according to one embodiment;

FIG. 7a-7c illustrate rotating the virtual space in an enhanced computing environment, according to one embodiment;

FIG. 8 illustrates rotating individual elements in an enhanced computing environment, according to one embodiment;

FIG. 9a-9b illustrate exemplary forms of the input pane for a control bar, according to one embodiment;

FIGS. 10a-10c illustrate a control bar with respect to the computer display, according to one embodiment;

FIG. 11 illustrates exemplary operations of contextual advertising triangulation, according to one embodiment;

FIG. 12 illustrates an implementation of an enhanced computing environment on a database server, according to one embodiment; and

FIG. 13 illustrates interactions among the user, third-party users, and the server, according to one embodiment.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not describe every aspect of the teachings disclosed herein and do not limit the scope of the claims.

### DETAILED DESCRIPTION

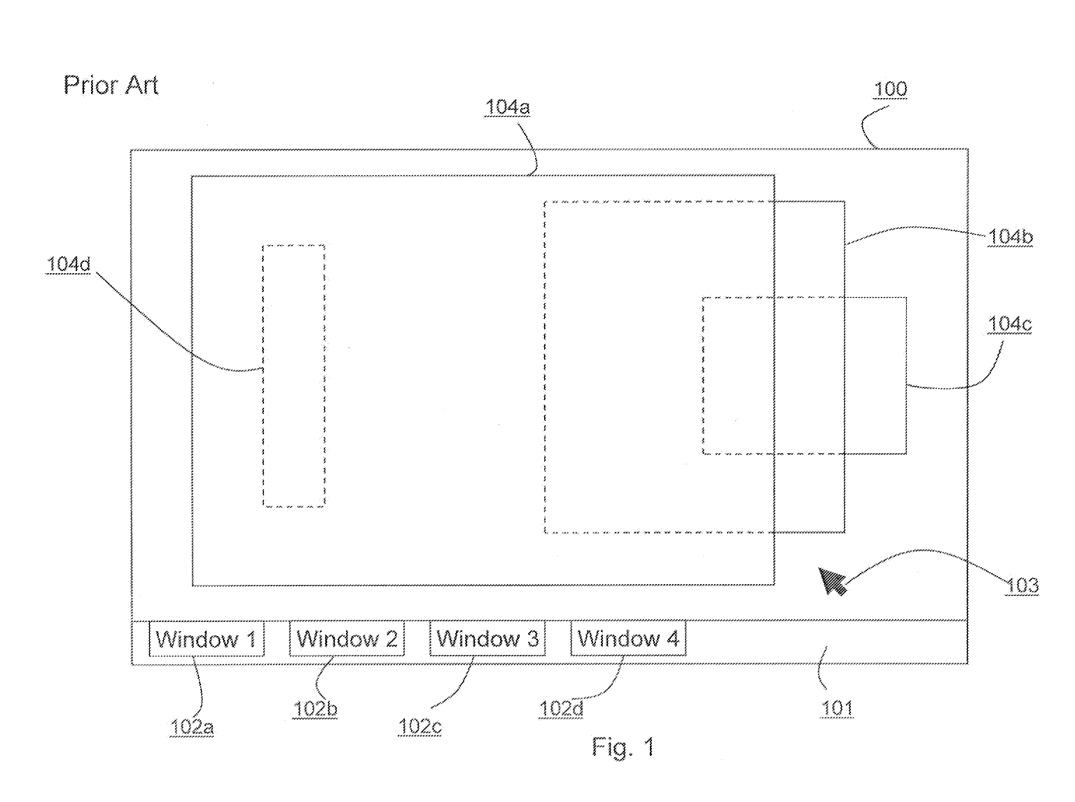

FIG. 1 illustrates a prior art computing environment. Computer display 100 is used to display the computer environment, which includes a taskbar 101, multiple application windows (104a-104d), and a mouse cursor 103. The taskbar 101 contains a set of links 102a-102d. The set of links 102a-102d may be used to select and activate corresponding application windows. For instance, if the user selects link 102d with the mouse cursor 103 and clicks on the mouse, the corresponding window 104d is brought on top of window 104a instead of being hidden underneath it.

As shown in FIG. 1, the elements are ‘stacked’ on top of each other such that newly generated elements obstruct the user's view of the existing elements. Broken lines indicate the portions of application windows 104b-104d that are hidden under another one or more application windows. Hidden portions of a window are generally not visible to the user. For instance, the user would not be able to see any part of application window 104d without moving or resizing application window 104a or bringing window 104d to the top by selecting it. Obstructing the view of some elements may be undesirable to the user but nonetheless unavoidable, due to insufficient display space.

### Enhanced Computing Environment

### Virtual Space

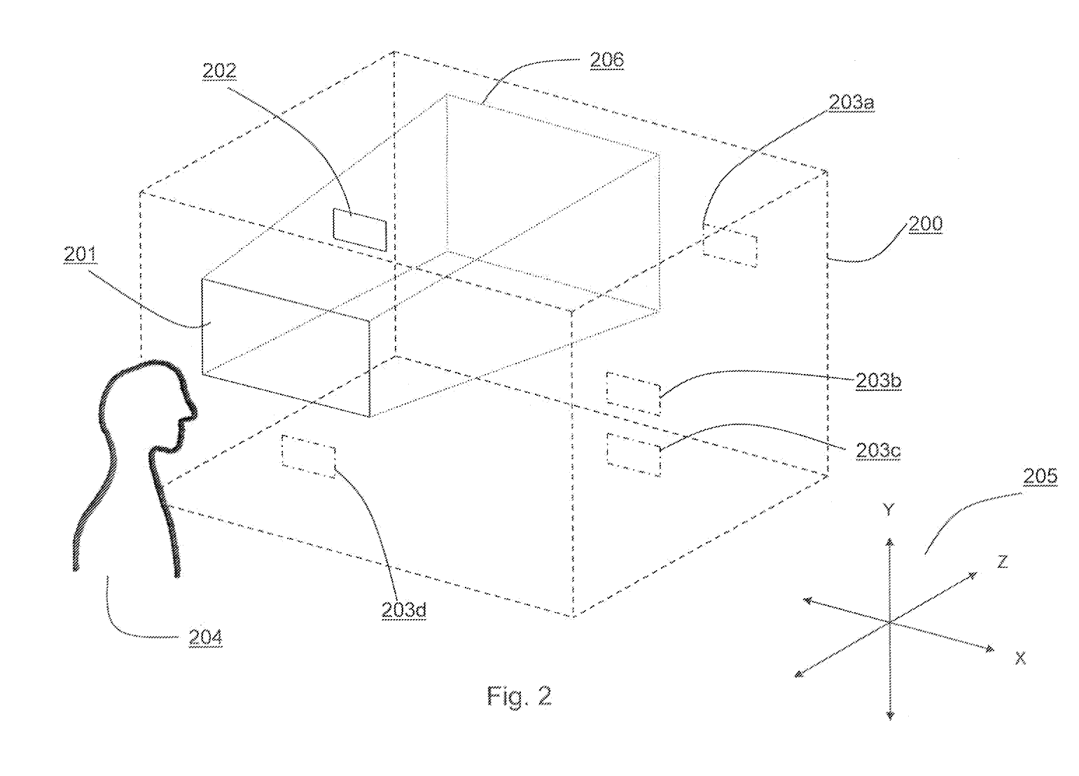

The presently disclosed method and system provide an enhanced computing environment for visualizing, managing, organizing, and interacting with digital content in an integrated and user-friendly manner. FIG. 2 illustrates an exemplary enhanced computing environment with respect to the user's perspective, according to one embodiment. From the perspective of the user 204, the computing environment is a three-dimensional virtual space 200 that can be viewed through the computer display 201. The user's viewing range 206 into the virtual space 200 is illustrated using dotted lines. In this manner, the computer display 201 may be likened to a window for looking inside a room and the computing environment is no longer limited by the physical dimensions of the computer display 201. Although the virtual space 200 of the exemplary computer environment is shown to be confined by broken lines, an open unconfined virtual space is also contemplated. Consistent with one embodiment, the spatial dimensions of the computing environment may be user configurable. Multiple spaces may be created by the user and interlinked using elements that possess an additional linking function. Activating a linking element may cause the current virtual space to disappear and the current content to be unloaded while a new virtual space and its corresponding content appear.

Within the virtual space 200, elements 202 and 203a-203d may be placed anywhere and in any orientation. Elements 202 and 203a-203d may include files of any type, size, or format, such as WebPages, images, video clips, audio clips, documents, graphic files, and flash files. The content of the elements themselves may be displayed instead of default icons representing the elements. Elements within the virtual space 200 may be organized randomly, by keyword or tag, by date, by contextual relevance or by geometric arrangement. (e.g.—vertically, horizontally, grid format).

As FIG. 2 illustrates, element 202 is located within the user's viewing range 206 while elements 203a-203d are located beyond the user's viewing range 206. Elements 203a-203d located beyond the user's viewing range 206 cannot be seen by the user 204. The orientation and location of the elements within the virtual space may be identified with respect to a three-dimensional coordinate system having x, y, and z axes, according to one embodiment. For illustrative purposes, a directional indicator 205 is used to designate an exemplary three-dimensional coordinate system. Consistent with one embodiment, the coordinate system may be measured from the geometric center of the space, which may have (0,0,0) as (x,y,z) coordinates.

### Space Navigation

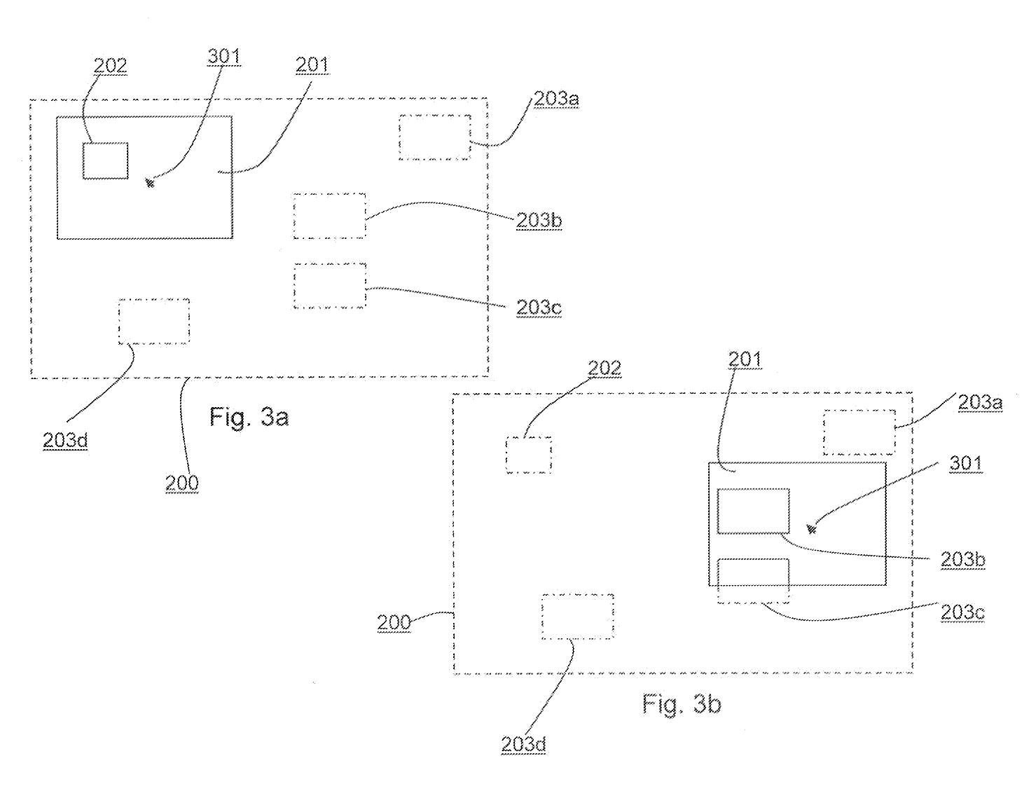

If the user desires to view or interact with element 203b, the user may do so by navigating the user's viewing range 206 to encompass the element 203b, either partially or entirely. Navigation of viewing range 206 may be achieved by effectively moving the entire virtual space in any of the axial directions, or their combinations, demonstrated by indicator 205. FIGS. 3a and 3b illustrate exemplary two-dimensional navigation of the viewing range by moving the virtual space 200 of the enhanced computing environment along the xy plane, referred to as ‘panning’, according to one embodiment. Panning may be controlled through mouse movements or keyboard key strokes, which are translated into x and y movements of the virtual space 200. Panning using mouse movements may not require clicking on the mouse. The virtual space 200 may move in a defined direction when a defined keyboard key is depressed and may stop moving when the key is released. Other methods and devices for controlling movements, such as joysticks, touch or multi-touch screens, and inertial navigation controllers, are contemplated.

FIGS. 3a and 3b illustrate that moving the virtual space 200 in the upper-left direction (from the user's perspective) shifts the computer display 201 in the lower-right direction. Note that elements 202 and 203a-203d move along with the entire virtual space 200 while the mouse cursor 301 may remain substantially unmoved with respect to the computer display 201, according to one embodiment. Because the computer display 201, and hence the user's viewing range, is shifted to encompass element 203b and partially element 203c in FIG. 3b, the user can then view and interact with elements 203b and 203c. Note that element 202 is no longer in the user's viewing range in FIG. 3b.

Elements located outside of the user's viewing range may be ‘disabled’ to reduce unnecessary computer processing and memory requirements. This may be implemented using a timed stacking module to monitor the geometric coordinates of the virtual space with respect to the computer display and to determine which elements should be loaded onto and unloaded from the stack. Additionally, a stack thread may manage the loading and unloading processes. Elements may be disabled by loading their content onto the stack. Conversely, elements may be reactivated by unloading their content from the stack.

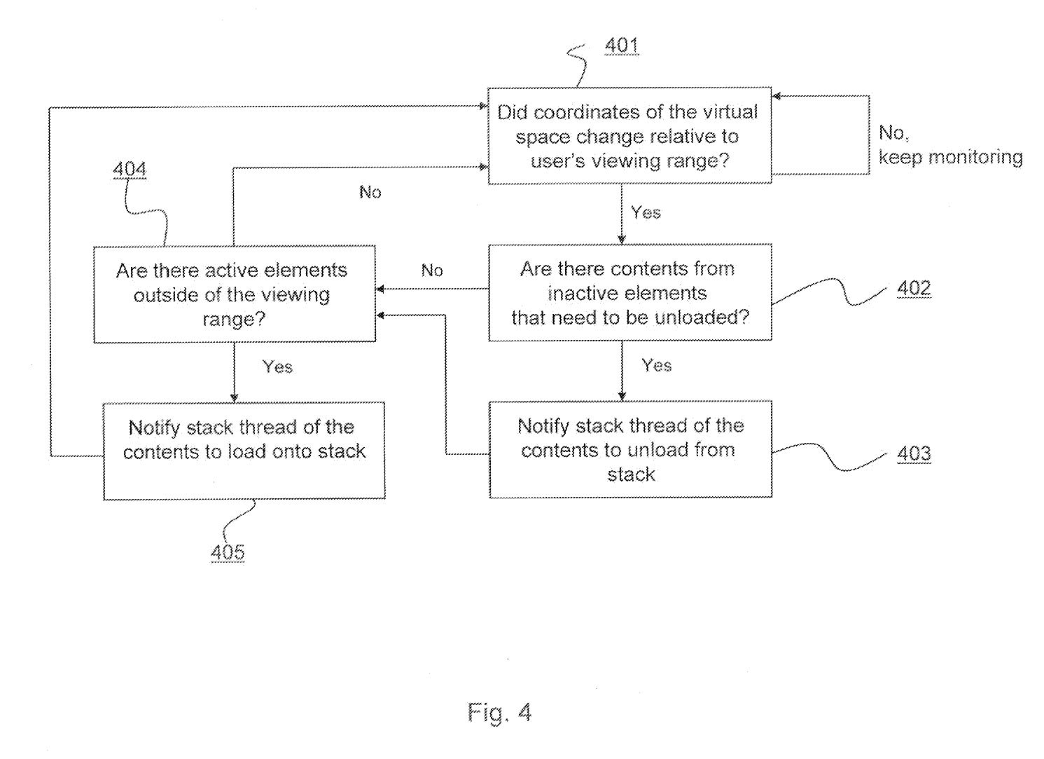

FIG. 4 illustrates a flow-chart of exemplary operations of the timed stacking module, according to one embodiment. At 401, the timed stacking module continuously monitors the coordinates of the virtual space relative to the computer display. If the virtual space moved from its previous location, resulting in a change in the coordinates, operation proceeds to 402 to determine whether there is content on the stack that need to be unloaded. Content from an inactive element needs to be unloaded from the stack if the inactive element comes within the user's viewing range. If no content needs to be unloaded, operation proceeds to 404. If content needs to be unloaded from the stack, the stack thread is notified at 403 of what content to unload before proceeding to 404. At 404, the timed stacking module determines whether there are active elements that are now located beyond the user's viewing range. If there are none, operation returns to 401. Otherwise, operation proceeds to 405 to notify the stack thread of the content to load onto the stack. Operation then returns to 401 to continue monitoring the coordinates of the virtual space. Thus, as the virtual space is panned with respect to the computer display, new elements may be continuously loaded onto the stack while existing elements may be continuously unloaded from the stack. This method significantly reduces the system resource requirements compared with traditional operating system methods of running open application windows.

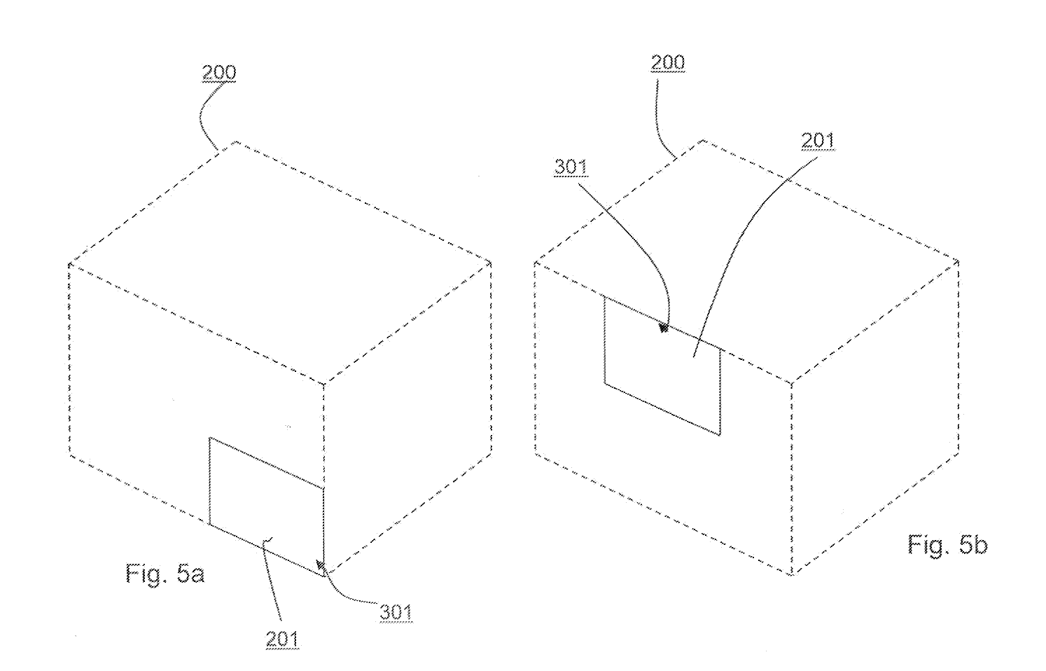

According to one embodiment, the user may pan the virtual space 200 by moving the mouse cursor within the boundaries of the computer display 201, which is linearly mapped to correspond to the absolute x and y dimensions of the virtual space 200. For instance, FIG. 5a illustrates that if the cursor 301 is moved to the bottom right corner (from user's perspective) of the computer display 201, the virtual space 200 is positioned such that the computer display 201 offers the user a view into the bottom right portion of the virtual space 200. Similarly, FIG. 5b illustrates that if the cursor 301 is moved to the top center (from user's perspective) of the computer display 201, the virtual space 200 is positioned such that the computer display 201 offers the user a view into the top center portion of the virtual space 200.

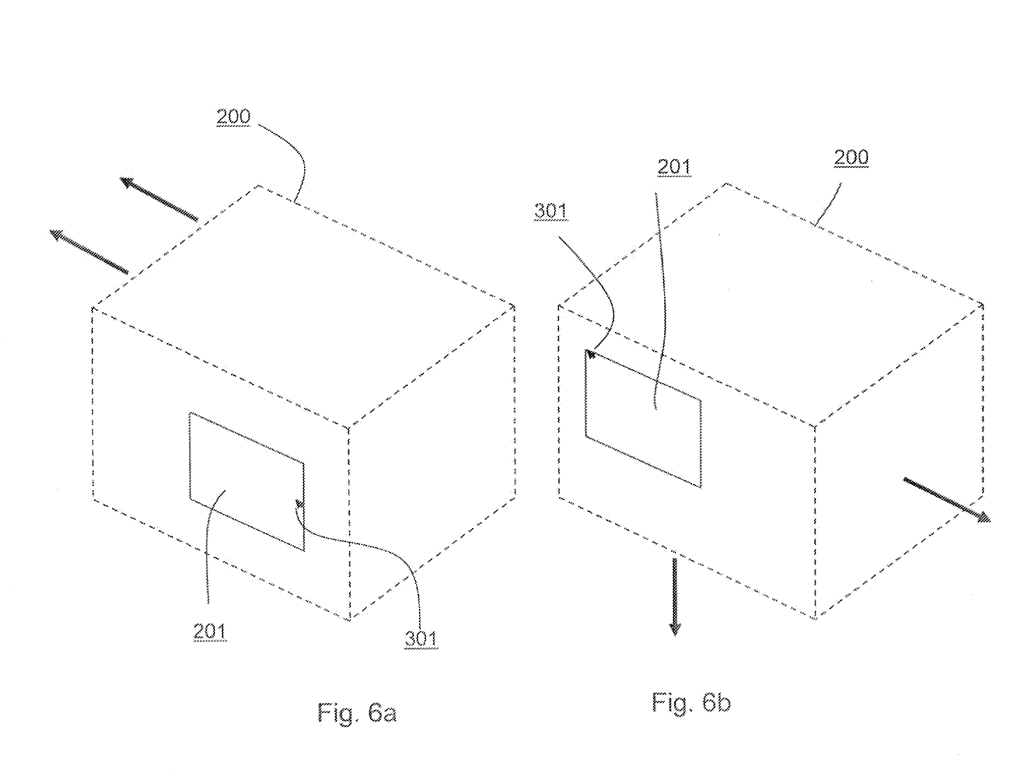

According to one embodiment, a constant space translation function may be implemented for panning a large or open virtual space. When the mouse cursor resides substantially near an edge of the computer display, the translation function may cause the virtual space to move towards the opposite edge of the computer display. For instance, FIG. 6a illustrates that when the cursor 301 is substantially close to the right edge (from the user's perspective) of the computer display 201, the virtual space 200 moves towards the left side of the computer display 201. When the cursor 301 is close to more than one edge, the virtual space 200 may move in a combination of directions, as FIG. 6b illustrates. When the cursor 301 is substantially close to both the top and the left edges (from the user's perspective) of the computer display 201, the virtual space 200 moves both towards the bottom and towards the right side of the computer display 201. Whether the cursor 301 is close enough to the edge to activate the translation function may be determined by how many pixels away the cursor 301 is from the computer monitor edge. When the virtual space 200 has been moved such that the absolute edge of the virtual space 200 coincides with the edge of the computer display 201, the client may monitor the period of time the cursor stops at the edge of the space. At the end of that time period, the virtual space 200 may be dynamically expanded in all three dimensions.

Virtual space may also be moved in the z direction, referred to as ‘zooming’, such as by scrolling the mouse wheel or by using keyboard keys. Moving the virtual space in the z direction changes the user's depth of perception of the elements within the virtual space. For instance, as the virtual space moves away from the user, elements may appear farther from the user, and thus, appear to be smaller and less detailed. On the other hand, as the virtual space moves towards the user, elements may appear closer to the user, and thus, appear to be bigger and more detailed.

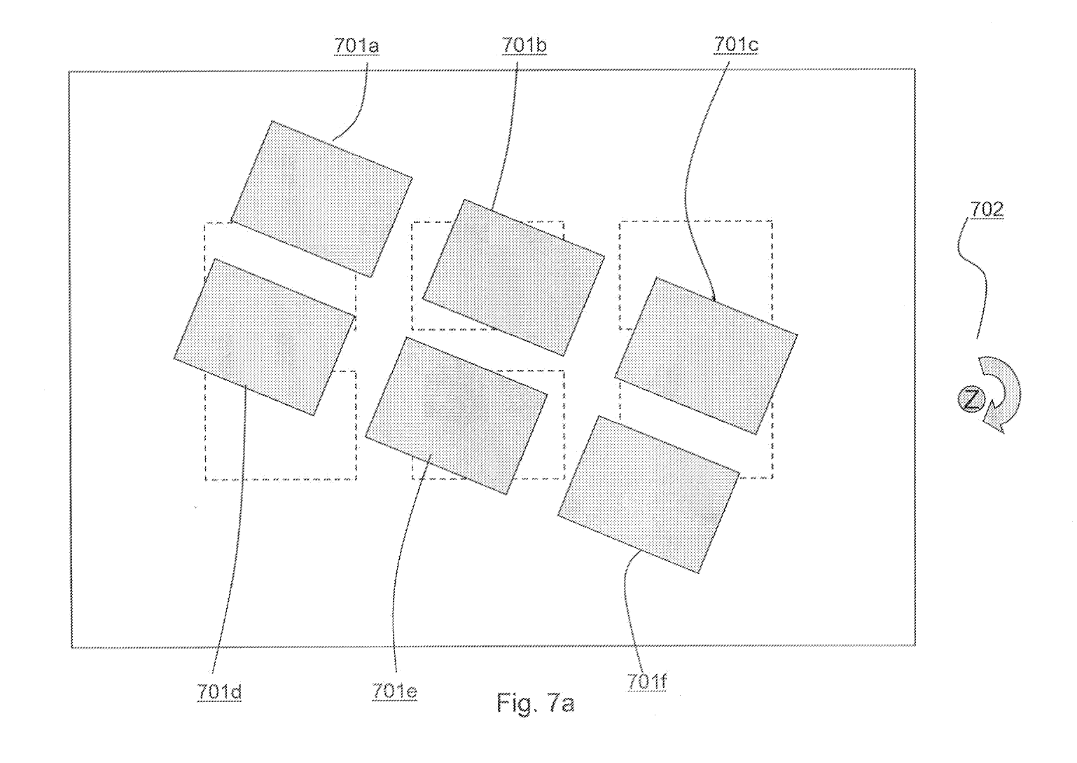

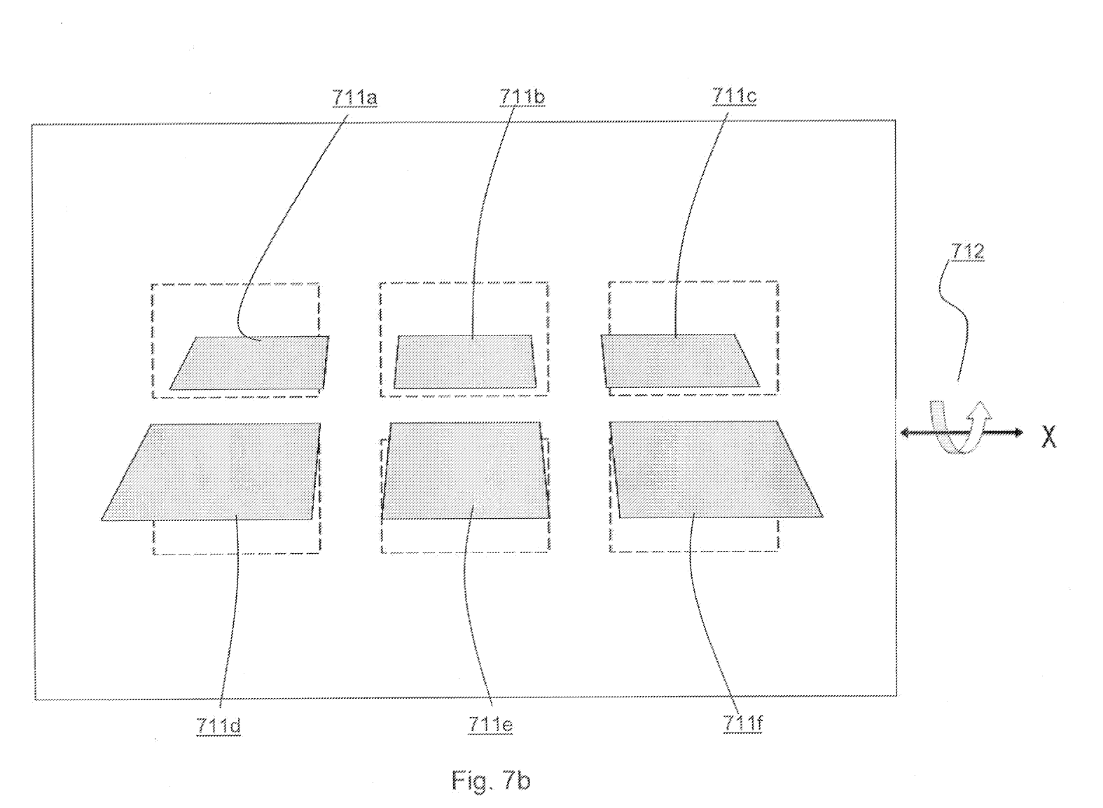

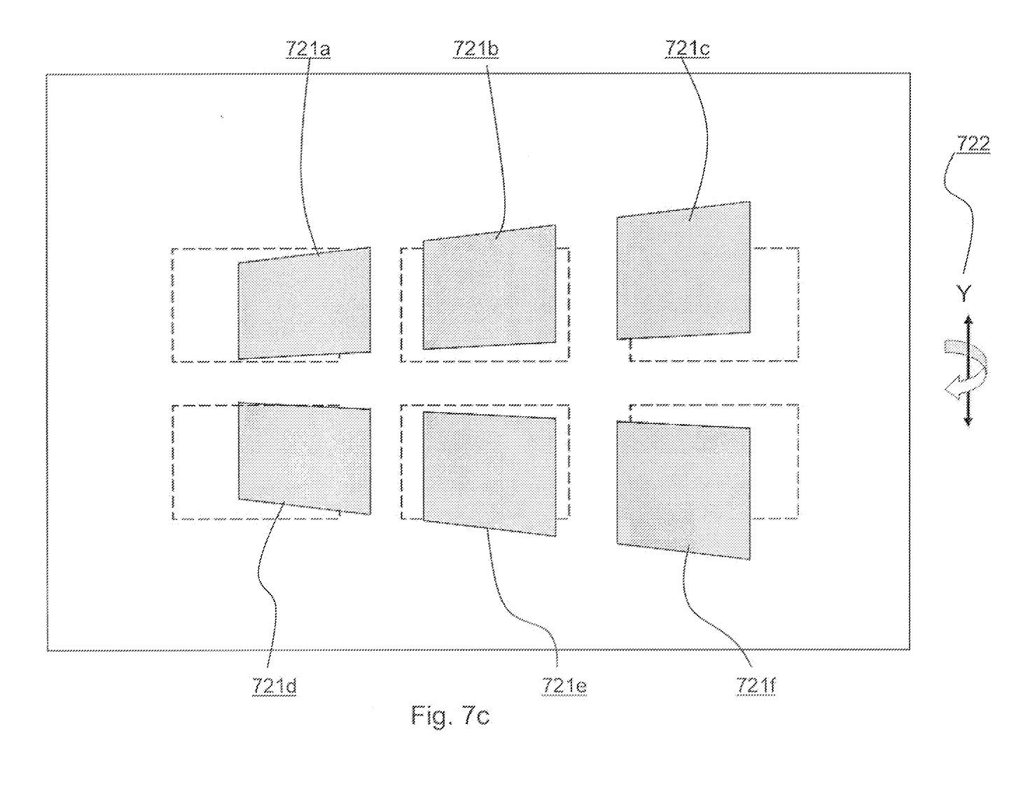

In addition to moving along the x, y, and z axes, the virtual space may also rotate around each of the axes or their combinations. FIG. 7a illustrates rotating the virtual space counterclockwise (user's perspective) around the z axis. Directional indicator 702 indicates that the z axis runs perpendicularly through the plane of FIG. 7a. Note that elements 701a-701f rotate around the z axis along with the virtual space. Broken lines are used to indicate the orientation of elements 701a-701f prior to rotation. FIG. 7b illustrates rotating the virtual space around the x axis in the direction indicated by directional indicator 712. Note that elements 711a-711f rotate around the x axis along with the virtual space. Broken lines are used to indicate the orientation of elements 711a-611f before rotation. FIG. 7c illustrates rotating the virtual space around the y axis in the direction indicated by directional indicator 722. Note that elements 721a-721f rotate around the y axis along with the virtual space. Broken lines are used to indicate the orientation of elements 721a-721f before rotation.

### Elements

Besides navigating the virtual space, a user may manipulate individual elements within the virtual space. For instance, the user may move each element to a different location within the virtual space or rotate each element around the x, y, and z axes or their combinations. Consistent with one embodiment, the user may move an element along the xy plane by navigating the mouse cursor over the element, depressing a mouse button, dragging the element to a new location by moving the mouse cursor, and then releasing the mouse button. Other methods and input devices for moving elements within the virtual space are contemplated.

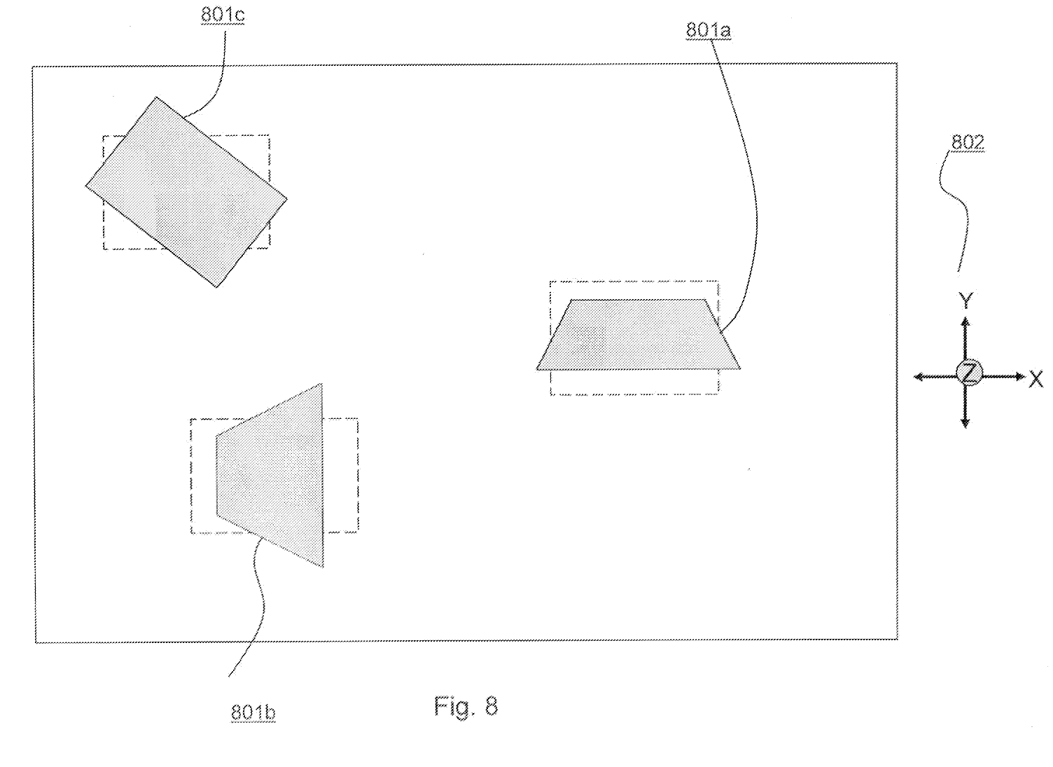

FIG. 8 illustrates exemplary elements 801a-801c being rotated around the x, y, and z axes, respectively. Broken lines are used to indicate the orientation of elements 801a-801c before rotation. Directional indicator 802 indicates the orientation of the axes with respect to the FIG. 8. To rotate an element in a preset direction around the z axis, a control point at the geometric center of the element may be activated by moving the mouse cursor over the control point and depressing the mouse button. The element may stop rotating when the mouse button is released. To rotate an element around the x or y axis, one or more designated keys on the keyboard may be depressed. The element may stop rotating when the keys are released. Other methods and input devices for controlling the rotation of elements are contemplated.

Each element may have a control layer that can be configured for communication, interaction, manipulation or other controls. For instance, the control layer may be used to associate an element with a link for ‘jumping’ to another virtual space. As mentioned earlier, multiple virtual spaces may be created by the user. Activating a link to another virtual space may cause the current virtual space to disappear and the current content to unload while a new virtual space and its corresponding content appear. The link may appear as an icon on the element control layer or as a mask on the entire control layer such that double clicking the left mouse button on the activated element activates the linking function. Other methods for accessing the control layer are contemplated.

A library of default control commands may be associated with the control layer, which can be edited in a command menu. The command menu may be activated, for instance, by clicking the right mouse button when the cursor is positioned above the element. An edit control command from the menu may be used to activate a control layer grid showing a pixel-level coordinate system that corresponds to the dimensions of the element. Thus, a location within the element may be selected by addressing a coordinate on the coordinate system. Once the location for establishing a control point is selected, a menu may appear listing available control point functions, from which the user may assign one or more functions to the established control point.

Element controls may be standard, user configured, or developed to access an Application Programming Interface (API) for additional functionality. User configuration may be implemented through user-friendly, macro-based action scripts, which may be constructed as a English language sentence of actions in a time based sequence, according to one embodiment.

### Non-Elements

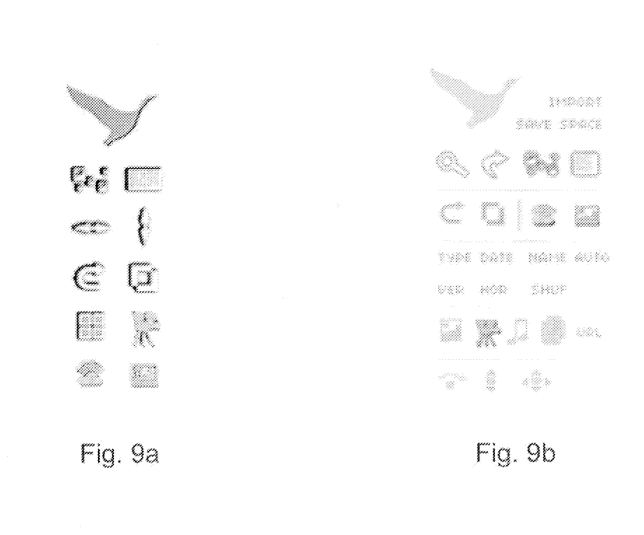

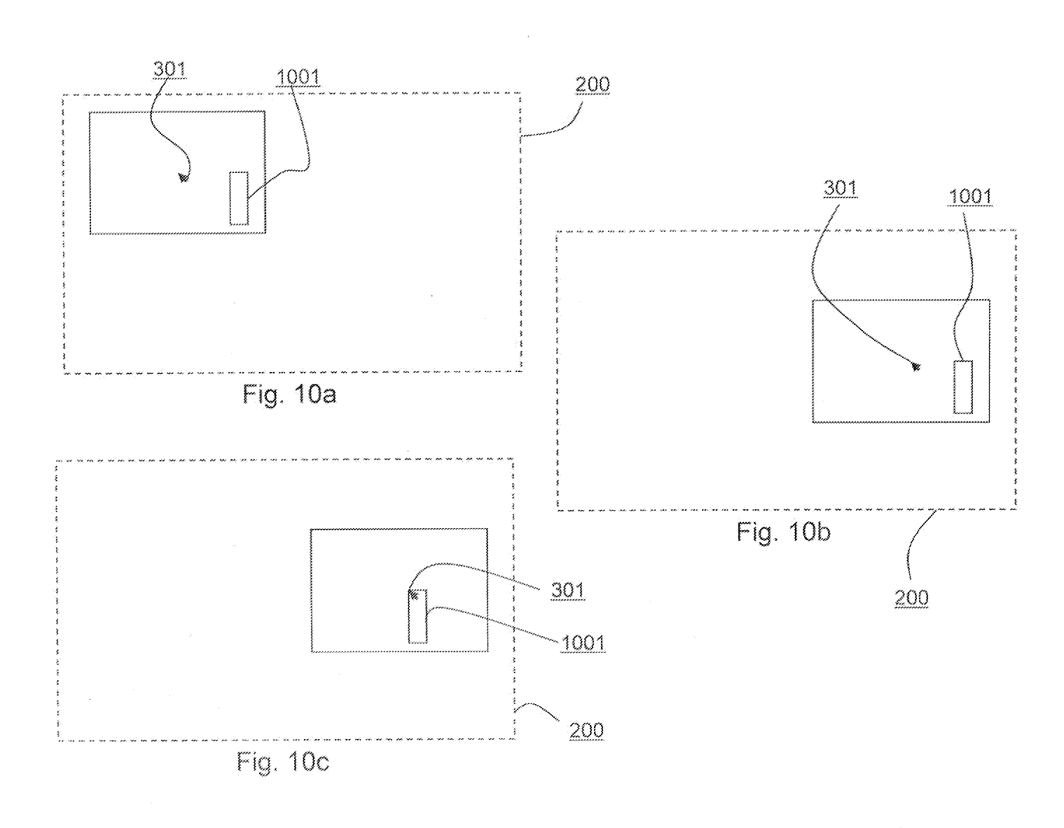

A control bar is a non-element that may exist within each virtual space. The user may activate functions, filters, and controls from the control bar, for instance, by navigating the mouse cursor over buttons on the control bar and clicking the mouse. The control bar may be used to toggle between modes for panning or rotating the virtual space or to set the organization schemes of elements. FIGS. 9a and 9b illustrate exemplary forms of the input pane for a control bar. Consistent with one embodiment, the control bar 1001 remains substantially unmoved with respect to the computer display when the user pans the virtual space 200, as illustrated by FIGS. 10a and 10b. When the mouse cursor 301 is not residing over any portion of an element (i.e.—over the background or a wall), clicking on the mouse may result in the control bar moving to the position where the mouse was clicked, as shown between FIGS. 10b and 10c. The control bar may move without transition to the position where the mouse is clicked. The top left corner of the control bar 1001 may align with the mouse cursor 301.

A virtual space may also include non-element components such as walls, backgrounds, hooks, connectors and flows. These non-element components add contextual framework to informational elements. Walls and backgrounds may be used to provide a geometric and visual boundary to the space, the parameters of which may be user configurable or defined by software or both. The visual format of the background may be defined from image files. Hooks are user-defined point entities that may be translated into x, y, and z coordinates such that one of the coordinate axes is coincident with a background or wall. A hook serves as a fixed control point and may be visually manifested in the space as a user-defined object that has no content. Instead, a hook may have one or more interfaces for activating user-defined actions. These interfaces may take the visual form of buttons, listboxes, dials, knobs, and other control surface features found in physical or simulation control or software modeling systems. User-defined actions may include controls to open text, voice or video communication dialogues with other users, controls to jump from one space to another, and controls for contextual mapping. Connectors and flows may be used by the user to connect two elements together. The component may include an activated text bar to describe a relationship. Flows are connectors associated with a specific direction in addition to functioning as a connector between two elements. Connectors and flows may be defined by the user to possess multiple connection points as required.

### Advanced Capabilities

### Hypertext Markup Language

In addition to standard configurable options, the user may implement advanced utility functions and customizations by creating scripts using a modified Hypertext Markup Language built upon space specific Application Programming Interfaces (API). The markup language may consist of additional terms and commands specific to the presently disclosed system and that describe geometric, topological and semantic relationships, and interactions among the user, the space, and the elements. For instance, the commands may include: actions, positions, motions, sizes, relative contexts, controls, visualization effects, locations at the element level, patterns, topologies, time functions, and shape (geometry) functions at the space level.

A script may be applied to one or more elements or to the virtual space. To create an element-level script, the user may access a scripting element, for instance, through the element's control layer. To create a space-level script, the user may access a scripting element, for instance, by clicking the right mouse button while the mouse cursor is on the background or on a wall of the virtual space. An element-level scripting element may contain existing scripts associated with the element. Similarly, a space-level scripting element may contain existing scripts associated with the virtual space. The user may edit existing scripts or create new scripts within the script element.

### Pixel Level Analytics

The space, the element, and the non-element components may be addressable by Hypertext Markup Language and Application Programming Interface calls at the pixel level and upwards. Each individual pixel within an object may synchronize with the space context layer by having individually assigned locator addresses. Each pixel may be assigned an address that can be used to input and extract events and data that were assigned to that pixel individually or spatially relative to it. Each pixel may also reserve multiple addresses that can consist of all the elements of the context layer, including but not limited to time data, spatial data, and metadata providing real-time and historical event tracking functions.

### Contextual Relations

While topological or geometric positioning of elements relative to each other may be established manually by the user, it is contemplated that the positioning of elements may be automatically established based on context or text matching. To enable context or text matching, each element may possess a context layer as well as associated tags, keywords and associated filenames. The context layer of an element or a pixel may contain multiple instances of metadata including time, date, type, space, location, content details, identification of surrounding elements, control points, and data specific information. Additionally, the metadata may directly relate to content such as text within a document or geometric recognition node points within an image for identifying a particular item in the content. By associating contextual information with elements, it is possible to implement a search capability by context or text matching multiple combinations of elements within a space and then algorithmically identifying cross correlations between the searches and enabling multiple instances of search references. The process is iterated until further cross matching and cross referencing of search terms reveals no further optimization in search result.

Multiple associations of search terms create cross association and subsequent rearrangement of the elements within the virtual space. The associations may occur by relative geometric positioning within a space or by manually positioning elements to within the vicinities of each other. Complex association algorithms may be established using the Hypertext Markup Language, introduced earlier. If necessary, connectors and flows may be used to maintain a visible architecture of context. Geometric rearrangement may be set in the preferences to enable the virtual space to automatically position elements in relation to specific metadata with multiple cross references within a single space or other spaces.

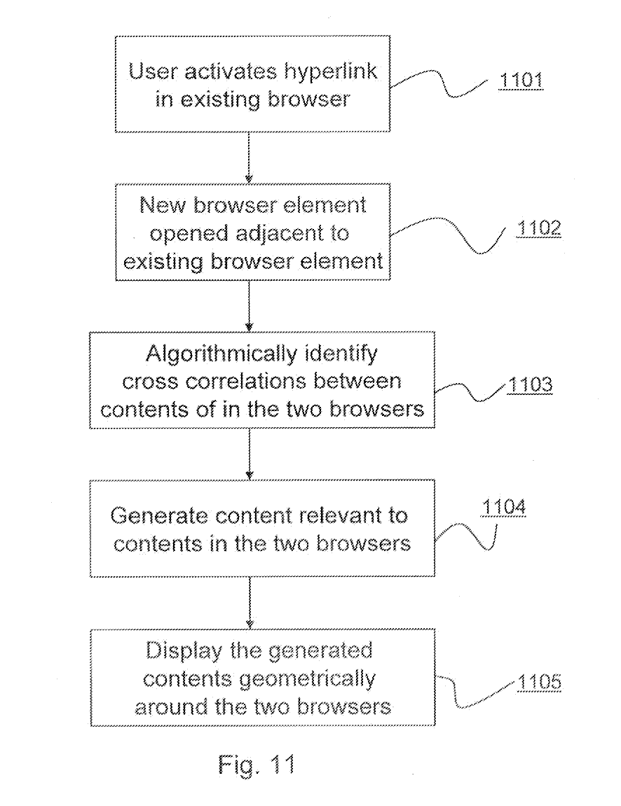

The ability to automatically rearrange elements based on contextual relationships between elements may be used to add value to hyperlink entries on a standard website. One instance of use is contextual advertising triangulation, as illustrated in FIG. 11. When the user activates a hyperlink in a browser element at 1101, a new browser element may be opened adjacent to an existing browser element in the virtual space at 1102. The system may algorithmically identify cross correlations between the contextual data in the two browsers at 1103 and generate links, advertisements, or other content that are deemed relevant to the content in the two browsers at 1104. The generated content is then displayed in the geometric space surrounding the browser elements at 1105. Thus, contextual advertising triangulation may be achieved by utilizing context derived search results from matching and cross referencing multiple browser elements.

An entire space may contain multiple contextual layer relevancies calculated in real time, which offers the user a selection of highly specific search results in a three-dimensional environment. The application of contextual search is not limited to WebPages but may be applied to any element within a space or multiple spaces, including images, documents, games, or videos. Correlating multiple data types enhances the effectiveness of the contextual search. Existing search tools may be used in combination to create an enhanced level of search relevancy than otherwise possible from existing search capabilities. By enabling automatic contextual mapping of the elements within the virtual space, a semantic framework may be established by enabling multiple cross reference element searches to be carried out automatically within the space. This offers the user alternative suggestions for context sensitive results. Moreover, the results selected by the user for review within the space may reflect a greater degree of internal ranking.

### Inter-element Messaging

An inter-element messaging Application Programming Interface (API) provides element-to-element interaction. A sending element may notify the application of a requested outgoing transaction and the value of that transaction. The application may then track the user's mouse movement or other input from the sending element to the receiving element. The application will notify the receiving element callback of the transaction and the equivalent value. As soon as the receiving element notifies the application that the transaction was processed successfully, the application will relay the notice to the sending element. Elements may also be programmed to transfer data to other elements based on any combination of values that may be present in the context or address layer of another element or pixel.

### Implementation

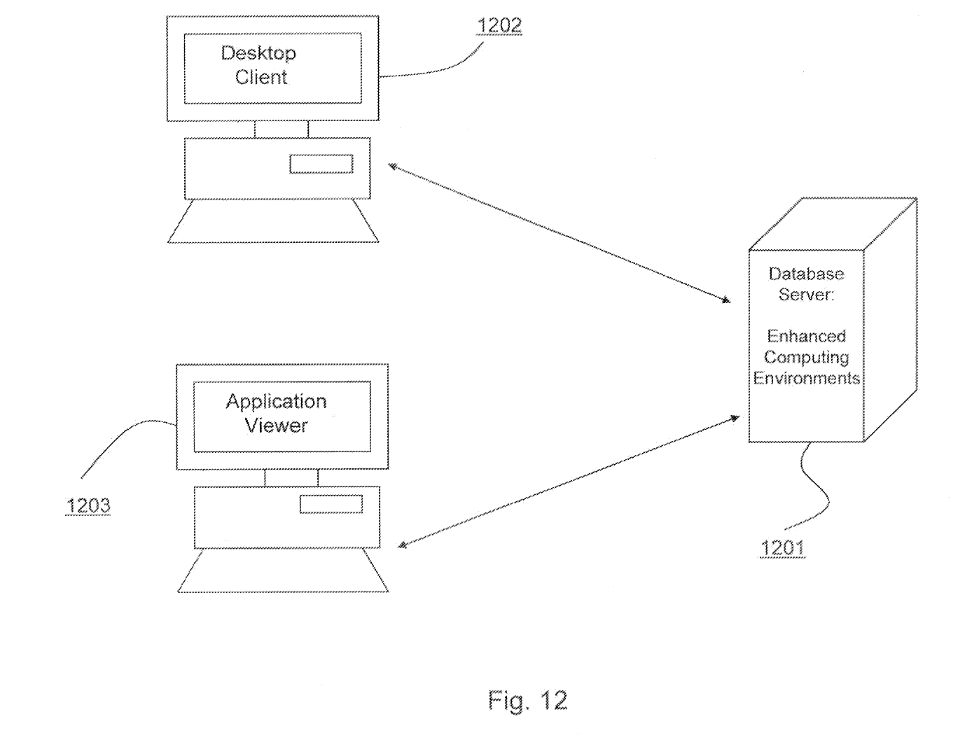

A user may create and share an enhanced computing environment using a desktop client that may be downloaded and installed. Additionally, using the desktop client, the user may edit, organize, manage, or search existing enhanced computing environments. Editing capabilities may be subject to the user's permission level. According to one embodiment, the desktop client may be coded in C++ while PHP scripts may be utilized to interact with the server based user content database tables. Alternatively, a user may access an enhanced computing environment through an application viewer on standard Internet browser. According to one embodiment, the application viewer may be coded in ActionScript 3.0 while PHP scripts may be used to interact with the databases. Other suitable computer languages may be used. FIG. 12 illustrates an exemplary implementation of an enhanced computing environment on a database server 1201. A desktop client running on computer 1202 and an application viewer running on computer 1203 may access the database server 1201 through a local network, the Internet, or any multi-user computing network. Multiple computing environments may be hosted on a server and multiple users may access the server simultaneously via application viewers or desktop clients.

To import element content into the virtual space, the desktop client may access and edit data from various sources, including the local computer (fixed or mobile) where the application is installed, the web, the cloud, specified servers, and mobile cellular devices. Content from the local computer may be user defined in the global space settings to remain in existing directory structures or to be moved into newly defined directories within the root content directory of the space. With either method, the data can be accessed and organized from within the space. External content may be accessed via scripts and server level databases that synchronize with the client database on the computer. Database tables may identify control and context layers as well as encompass definitions of element content, location, and utility as content layer attributes. Consistent with one embodiment, database tables may include the following information:

a. file: information about each space element

b. filegroup: information about groups of elements

c. fileingroup: information about elements within groups

d. joinerinspace: table that links spaces with users

e. space: information about each space

f. status: info about user sessions

g. user: info about registered users

Because element locations are maintained in database tables, the enhanced computing environment remains location transparent to the user even when integrating element content from multiple sources.

An exemplary database server structure may include MySQL databases and PHP scripts that interact with them. The PHP scripts may allow both the application viewer and the desktop client to add and upload elements to the database servers, to add information about local and third party content, to update or delete the state and parameters of the elements, to register new users and new spaces, to register user sessions, and to perform full text searches within the text associated to the spaces and their elements.

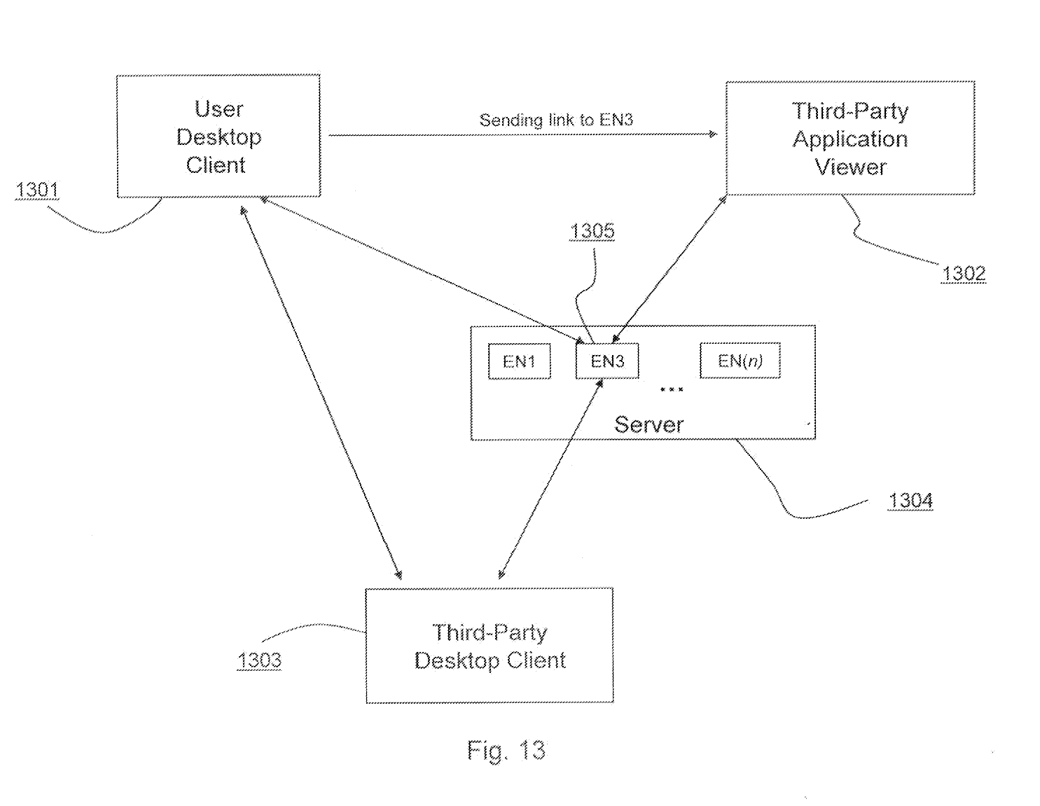

After creating an enhanced computing environment, the user may share it with a third-party user, for instance, by sending a link to the computing environment to a third-party user. Following the link, the third-party user may access the computing environment. The user may also configure the computing environment to be searchable on the server. FIG. 13 illustrates exemplary interactions among the user 1301, third-party users 1302 and 1303, and the server 1304. After receiving a link to an enhanced environment 1305 from user 1301, third-party user 1302 may follow the link to access computing environment 1305 hosted on server 1304. As shown, both third-party user 1302, using an application viewer, and third-party user 1303, using an desktop client, may access the same environment 1305 on the database server 1304 by addressing the same database tables and server based content. Although a link to the computing environment may not have been sent to user 1303, user 1303 may find the environment by performing a search if user 1301 configured the environment to be searchable. Data accessible by third-party users may be public or permission-based.

FIG. 13 further illustrates that user 1301 and user 1303, both using desktop clients, may connect with each other via a peer-to-peer connection to access enhanced computing environments created by the other. Specific ports using User Datagram Protocol (UDP) may be used to direct packet transmission from desktop client to desktop client without the intervention of server based communications, which enables real time collaboration within the enhanced computing environments.

We claim:

1. A system comprising:
a desktop client that generates a three-dimensional computing environment; and
a computer display that displays the three-dimensional computing environment, wherein the three-dimensional computing environment includes:
a three-dimensional virtual space having dimensions that appear to a user to be greater than the physical dimensions of the computer display, and
a plurality of elements containing imported digital content.

2. The system of claim 1, further comprising a database server that hosts the three-dimensional computing environment.

3. The system of claim 1, further comprising a timed stacking module to monitor the geometric coordinates of the three-dimensional virtual space with respect to the computer display and to determine which of the plurality of elements are loaded onto and unloaded from a stack.

4. The system of claim 1 further comprising scripts, written in a modified Hypertext Markup Language built upon space specific Application Programming Interfaces that implement advanced utility functions and customizations.

5. The system of claim 1, wherein the three-dimensional environment further comprises a control bar that activates specified functions, filters, and controls.

6. The system of claim 1, wherein the three-dimensional environment further comprises hooks that serve as fixed control points visually manifested in the space as user-defined objects for activating user-defined actions.

7. The system of claim 1, wherein the three-dimensional virtual space, along with the plurality of elements, may be rotated in any direction with respect to the computer display.

8. The system of claim 1, wherein the three-dimensional virtual space, along with the plurality of elements, may be moved in any direction with respect to the computer display.

9. The system of claim 1, wherein the dimensions of the three-dimensional virtual space are user-configurable.

10. The system of claim 1, wherein one or more elements in the plurality of elements possess a linking function for jumping to another three-dimensional computing environment.

11. The system of claim 1, wherein one or more elements in the plurality of elements possess context layers used for creating contextual relationships between the one or more elements.

12. The system of claim 11, wherein the one or more elements may be rearranged based on the contextual relationships between the one or more elements.

13. A method comprising:
generating a three-dimensional computing environment;
importing digital content into the three-dimensional computing environment; and
displaying the three-dimensional computing environment on a computer display, wherein the three-dimensional computing environment includes:
a three-dimensional virtual space having dimensions that appear to a user to be greater than the physical dimensions of the computer display, and
a plurality of elements containing the imported digital content.

13. The method of claim 13 further comprising uploading the three-dimensional computing environment to a database server.

14. The method of claim 13 further comprising monitoring the geometric coordinates of the three-dimensional virtual space with respect to the computer display and determining which of the plurality of elements are loaded onto and unloaded from a stack.

15. The method of claim 13 further comprising implementing advanced utility functions and customizing the three-dimensional computing environment based on scripts written in a modified Hypertext Markup Language built upon space specific Application Programming Interfaces.

16. The method of claim 13 further comprising defining hooks that serve as fixed control points visually manifested in the space as user-defined objects for activating user-defined actions.

17. The method of claim 13 further comprising rotating the three-dimensional space, along with the plurality of elements, in any direction with respect to the computer display.

18. The method of claim 13 further comprising moving the three-dimensional space, along with the plurality of elements, in any direction with respect to the computer display.

19. The method of claim 13 further comprising configuring the dimensions of the three-dimensional virtual space.

20. The method of claim 13 further comprising jumping to another three-dimensional computing environment when a linking function is activated in one or more elements in the plurality of elements.

21. The method of claim 13 further comprising creating contextual relationships between one or more elements in the plurality of elements based on contextual information possessed by the one or more elements.

22. The method of claim 21 further comprising rearranging the one or more elements based on the created contextual relationships.

23. The method of claim 13 further comprising dynamically expanding the dimensions of the three-dimensional virtual space after a period of time in which an edge of the three-dimensional virtual space coincides with an edge of the computer display.
